(19) United States
(12) Patent Application Publication
(10) Pub. No.: US 2012/0228378 A1
(43) Pub. Date: Sep. 13, 2012

(54) PRODUCT MARKER, AUTOMATIC PICKING MACHINE AND ORDER-PICKING METHOD

(76) Inventor: Max Winkler, Graz (AT)

(21) Appl. No.: 13/419,832

(22) Filed: Mar. 14, 2012

Related U.S. Application Data
(63) Continuation of application No. PCT/EP2010/060811, filed on Jul. 26, 2010.

(30) Foreign Application Priority Data
Sep. 14, 2009 (DE) 10 2009 042 145.9

(51) Int. Cl. G06F 17/40; G06F 17/00; B65G 59/00

(52) U.S. Cl. 235/385; 221/7; 700/231; 235/375

(57) ABSTRACT

A product marker, an automatic picking machine and a method for recognizing change of product batches. The automatic picking machine comprises: a dispenser having a substantially circulating driver for automatically separating products which are stored in stacks and by one type only within chutes of the automatic picking machine, which are substantially orientated vertically. The dispenser device is arranged preferably at a lower end of the chutes. The product marker is formed such that the product marker is inserted between products, which are belonging to different batches, in one of the chutes and dispensed together with a first product or a last product of a product batch by the dispenser. The product marker comprises a sequence of characteristic signal triggers, which are scanned and registered by a reading unit if the product marker passes the reading unit.

### CROSS REFERENCES TO RELATED APPLICATIONS

This application is a continuation of international patent application PCT/EP2010/060811 (WO 2011/029659 A1), filed on Jul. 26, 2010 designating the U.S., which international patent application has been published in German language and claims priority from German patent application DE 10 2009 042 145.9, filed on Sep. 14, 2009. The entire contents of these priority applications are incorporated herein by reference.

### BACKGROUND OF THE INVENTION

The present invention relates to a product marker for use in an automatic picking machine. Further, the invention relates to an automatic picking machine which is suitable for handling corresponding product markers. Additionally, the present invention relates to a method for recognizing change of product batches during the products are dispensed, the products being stocked together with the product markers in chutes of an automatic picking machine.

### RELATED PRIOR ART

An automatic picking machine is a fully-automated system, in particular for picking small pieces. A chute-picking machine represents such an automatic picking system, wherein article units or products are delivered by means of chutes for collecting orders. Particularly, a chute-picking machine can be used with smaller units, which are packed in a stable manner, as encountered in the field of pharmaceuticals, for example. Due to the (typical) parallel operation of a number of chute-picking machines having a common belt conveyor, which conveys items away, a very high performance can be achieved (for example, several 10,000 pieces each hour).

Chute-picking machines are also known and designated as “A-shaped frames” since a base frame of the automatic picking machine often has an A-shaped cross section. One automatic picking machine of this type is exemplarily disclosed in the document U.S. Pat. No. 5,271,703 A.

Typically, a conveying belt travels through legs of the frame of the automatic picking machine, the conveying belt serving for receiving dispensed (i.e. ejected) articles and products. The chutes of the machine, which are intended for stocking the products, are attached laterally to the outside of the frame of the automatic picking machine. In this context, the chutes are substantially orientated vertically for allowing performance of a product tracking by means of gravity. A number of chutes of the automatic picking machine are arranged side-by-side along a longitudinal direction of the automatic machine. Typically, a dispensing or ejecting mechanism is provided at a lower end of the chutes. For this purpose, traction devices are often used, which circulate endlessly in a vertical plane, comprising one or more drivers (cams) at an externally located side of a run thereof, in order to dispense a lowermost product of a product stack from one of the chutes towards the central conveyor.

The document U.S. Pat. No. 5,271,703 A proposes to not provide an individual dispenser for each of the chutes of the automatic machine. In particular, it is proposed to provide, besides some conventional stationary dispensers fixedly assigned respectively to one single chute of the automatic machine as before, also a number of dispensers which are supported along the longitudinal direction of the automatic machine in a displaceable manner. These displaceable dispensers can be driven individually, and can be moved independently from each other. While the stationary dispensers are used for A-type articles, or so-called fast-moving articles, the moveable dispensers are used for B-type or C-type articles, or so-called slow-moving products. B-type and C-type articles, or slow-moving products, are less often required in picking orders in accordance with an ABC distribution so that the moveable dispenser has sufficient time between individual ejection processes for driving to the next chute of the automatic machine while the stationary dispensers arranged beneath the A-type product chutes dispense a lot of products such as the fast moving or average-moving products (50 through 350 pieces each day, or 5 through 50 pieces each day).

The document DE 100 12 942 A1 discloses automatic picking machines, wherein respectively one single moveable dispenser serves all of the chutes of the automatic machine. These automatic picking machines, which are manufactured by the applicant of the document DE 100 12 942, are also sold under the product name “travelling dispenser” and can serve up to 55 chutes of the automatic machine, which are arranged one after the other, by means of one single dispenser.

An automatic picking machine enhanced in the light of these automatic picking machines is disclosed in the German utility model DE 20 2009 003 672 U1.

The European patent application EP 1 866 220 A discloses an order-picking method which uses Radio Frequency Identification (RFID) markers. The RFID marker is inserted between two products for labeling a change of product batch, the two products being arranged adjacent to each other and belonging to different product batches. Hereinafter, a batch is to be understood as an entirety of all units of a product, which are generated, manufactured or packed under identical conditions. A unique lot number (batch number) is usually assigned to such an entirety, and this number is often registered on the products of this lot. For example, in the pharmaceutical industry identical drugs having different expiration dates represent different product batches.

The order-picking method described in the document EP 1 866 220 is disadvantageous because antennas need to be used for detecting the RFID markers in order to allow recognition of the RFID markers, which are based on a transponder technology, in a pile of products collected for the purpose of processing a picking order, for example, on the central conveyor during passage of the different picking chutes.

The detection of the RFID marker spatially happens separately to the dispenser and the picking chute from which the RFID marker originates. In addition, this method is not suitable for providing information on a number of products belonging to a first product batch before the change of product batches has occurred. Of course, this also applies to the number of products of the second product batch.

The document DE 196 28 733 B4 discloses a method and device for storing and picking piece goods, wherein the piece goods are dispensed from a storage channel to a delivery station. For the purpose of a controlled delivery of the piece goods the type, the number, and the sequence of the piece goods in the storage channel 2 are entered into the control in terms of information, wherein piece goods of the same type, which form an assignment, are stored in the storage channel one after the other, wherein a separation device, which can be detected by sensors, is inserted between different assignments following each other within the storage channel, wherein the piece goods as well as the separation elements are scanned in the area of the delivery station for detecting the separation element(s), and wherein the assignment is changed in the control unit as a function of this detection.

Therefore, it is an object of the present invention to generate a concept which allows detection of a change of product batches in a technically simple manner, wherein, in particular, numbers of products pieces belonging to a first product batch and products pieces belonging to a second product batch are automatically detected at the same time.

### SUMMARY OF THE INVENTION

According to one aspect of the invention there is disclosed an automatic picking machine comprising: a chute for storing products of different product batches in a stack and by one type only; a dispenser having a circulating driver for automatically separating the products and being arranged at an end of the chute, wherein the dispenser is assigned to the reading unit scanning a product marker; a reading unit being arranged in an area of the dispenser and adapted to scan an object and transmit a signal; and the product marker for usage with the automatic picking machine, wherein the product marker is formed such that the product marker is insertable between such products in the chute, which are belonging to the different product batches, and is dispensable together with a first product or a last product of one of the product batches by means of the dispenser, wherein the product marker comprises a sequence of characteristic signal triggers which can be scanned and transmitted as a signal by the reading unit if the product marker passes the reading unit during an ejection process, wherein the product marker has a first leg extending in a plane in which the products within the stack lie on top of each other, and wherein the signal triggers have preset widths and are arranged one after the other at preset distances relative to each other along a dispensing direction; and an evaluation unit being adapted to examine a signal, generated from a scanned sequence of characteristic signal triggers when the product marker passes the reading unit during the ejection process, for a signal behaviour being characteristic for the dispensed product marker and differing from a typical signal behaviour caused by a combination of one of the products and the driver, if they are passing the reading unit solved by a product marker for usage in an automatic picking machine comprising a dispenser having a driver substantially circulating horizontally for automatically separating products, which are stored stackwise and by one type only within chutes of the automatic picking machine being substantially orientated vertically, wherein the dispenser preferably is arranged at a lower end of the chutes, and wherein the product marker is formed such that the product marker is inserted in one of the chutes between products belonging to different product batches, and is dispensed preferably together with a first or a last product of one of the product batches by means of the dispenser, wherein the product marker comprises a sequence of characteristic signal triggers scanned and registered by means of a reading unit if the product marker passes the reading unit arranged in the area of the dispenser.

According to another aspect of the invention there is disclosed marker for usage in an automatic picking machine, the automatic picking machine comprising: a chute; a dispenser having a circulating driver for automatically separating products, which are stored in a stack and by one type only within the chute; wherein the dispenser is arranged at an end of the chute; and a reading unit, which is arranged near the dispenser; the product marker being formed such that the product marker is insertable between such products in the chute, which are belonging to different product batches, and dispensable together with a first product or a last product of one of the product batches by means of the dispenser; wherein the product marker comprises a sequence of characteristic signal triggers, which can be scanned and transmitted as a signal by the reading unit if the product marker passes the reading unit during an ejection process, the reading unit being arranged in an area of the dispenser; wherein the product marker has a first leg extending in a horizontal plane in which the products within the stack lie on top of each other; and wherein the signal triggers have preset widths and are arranged one after the other at preset distances relative to each other along a dispensing direction.

According to still another aspect of the invention there is disclosed a method for recognizing a change of product batches during ejection of products being stored in a chute of an automatic picking machine, the automatic picking machine comprising: a chute for storing products of different product batches in a stack and by one type only; a reading unit; a dispenser having a circulating driver for automatically separating the products and being arranged at an end of the chute, wherein the dispenser is assigned to the reading unit scanning a product marker; and the product marker for usage with the automatic picking machine, wherein the product marker is formed such that the product marker is insertable between such products in the chute, which are belonging to the different product batches, and is dispensable together with a first product or a last product of one of the product batches by means of the dispenser, wherein the product marker comprises a sequence of characteristic signal triggers which can be scanned and transmitted as a signal by the reading unit if the product marker passes the reading unit during an ejection process, the reading unit being arranged in an area of the dispenser, wherein the product marker has a first leg extending in a horizontal plane in which the products within the stack lie on top of each other, and wherein the signal triggers have preset widths and are arranged one after the other at preset distances relative to each other along a dispensing direction; and an evaluation unit being adapted to examine a signal, generated by the scanning of the sequence of characteristic signal triggers of the product marker when the product marker passes the reading unit during the ejection process, on a signal behaviour being characteristic for the dispensed product marker and distinguishing from a typical signal behaviour caused by a combination of one of the products and the driver, if they are passing the reading unit; the method comprising the following steps: inserting the product marker into the product stack in the chute of the automatic picking machine for indicating a change of product batches; scanning dispensed products and product markers by means of the reading unit which is arranged immediately behind the chute at the dispenser; generating a signal behaviour being characteristic for the dispended product and the product marker dispensed during the ejection process; evaluating the generated signal behaviour by a comparison with at least one stored characteristic signal behaviour of the product marker; and if a characteristic signal behaviour of the dispensed product marker is recognized, identifying the product marker which was dispensed during the ejection process.

The signals can be caused in an optical, capacitive or magnetic manner. Preferably, signal triggers are used which act optically. The signal triggers can be detected preferably by means of a reading unit (sensor) which is already used for detecting a product ejection. Additional antennas, as they were required if RFID markers are used, are presently no longer required. Hence, the reading unit does not only register a product ejection but also counts a quantity of dispensed products, and registers the product marker of the invention, if ejected.

For this purpose, the signal triggers are arranged in a predetermined sequence, which can be recognized by the reading unit similar like a melody. It goes without saying that a number of different melodies can be used for labeling different changes of product batches.

Characteristic signal triggers comprise: through openings in a body of the product marker; metal stripes in a body of the product marker; stripes reflecting at different intensities; or surfaces having different dielectric regions.

The signal triggers are preferably arranged one after the other along a direction of an ejection movement with preset widths and/or distances.

For example, if through openings in a body of the product marker are used as the characteristic signal triggers, a reflection sensor or a light barrier can be used exemplarily as the reading unit. The reflection sensor emits a beam of light, which is reflected by the to-be-dispensed product and the body of the product marker, so that the beam of light can be detected by means of a receiver unit of the reflection sensor for generating a signal. If the body of the product marker comprises openings extending in a propagation direction of the original beam of light, in particular through openings, no reflection or a weaker reflection occurs during passage of the opening. This change of reflection is detected. Characteristic signal behaviours (“melodies”) are generated dependent on the size of the openings along the dispensing direction as well as dependent on the size of the distances between the openings along the dispensing direction. These “melodies” can be identified unambiguously in the detected signal behaviour, for example, by means of recognition software.

The same applies to a capacitive or inductive detection of the characteristic signaller. With a capacitive measurement the product marker can be a foil, the foil comprising areas of different electrical conductivities and being attached, for example, to a bottom of the product. With an inductive detection, for example, (ferromagnetic) metal stripes can be integrated into a body of the product markers. In this case, these metal stripes can be detected by a correspondingly equipped reading unit (e.g. Hall sensors).

As an alternative to the above-described openings, for example, also color stripes which are reflecting at different intensities can be certainly used.

The widths and distances of the characteristic signal triggers along the direction of an ejection movement cause the characteristic signals.

With a preferred embodiment the widths and/or distances thus represent a characteristic label of the product marker, wherein the characteristic label of the product marker can be identified unambiguously in a signal of the reading unit.

In particular, the signal triggers substantially extend transversally relative to an ejection movement direction.

This measure ensures that the reading unit can “see” the signal trigger in any event. Usually, the reading unit is arranged in a slightly displaced manner relative to a traction device of the dispenser. The traction device moves in an endlessly-rotating manner, usually in a vertical plane. In this case, the reading unit is located in a parallel vertical plane which is slightly displaced. The more the reading unit is displaced relative to the traction means, the broader the signal triggers should be in the transversal direction.

With a special embodiment the product marker is formed as a dummy.

This has the advantage that an identical time period is needed for dispensing the product marker like for dispensing the product. If the product marker, in the dispensing direction would be longer than a to-be-dispensed product, more time would be required for the ejection of the product marker than for the ejection of the product. Since the ejection often happens on a moving central belt passing continuously, on which so-called “windows” are defined for receiving products of one picking order, temporal aspects can play a significant role with regard to an ejection into the right window. If the product marker is used in terms of a dummy, the timing is independent of whether a product or the product marker is dispensed. However, in this case one more product needs to be dispensed.

Preferably, the product marker is substantially plate-like.

The product marker, in particular, is angled, wherein the first leg extends in a, preferably horizontal, plane in which the products within the stack lie on each other, and wherein an optional second leg extends in a vertical plane in which the driver is in contact with the product during an ejection. The second leg can be omitted if the first leg is sufficiently thick so that the first leg does not bend up during an ejection.

An angled product marker can be inserted safely between products in a chute of the automatic picking machine. The legs, which are usually arranged perpendicularly to each other, ensure that the product marker is always dispensed together with one of the products but never alone.

With another specific embodiment a stop element is provided in a plane extending parallel to the second leg, the stop element being connected to the first leg and preventing displacement of the product marker relative to the dispensing product during ejection, with which the product marker is in contact.

The stop element serves to be displaced relative to a contact surface of the product marker so that the characteristic signal trigger of the product is possibly covered which would prevent recognition of the sequence of the characteristic signal triggers by the reading unit. For example, if an optical reflection sensor is used as the reading unit, wherein in this case the product marker comprises, for example, through openings, the product could be pushed exactly above these openings if a stop element lacks, and thus cause a reflection where a reflection actually is not expected. In this case, the product marker could not be recognized by the reading unit.

The reading unit and the evaluation unit being in communication with the reading unit can recognize a change of product batches instantaneously in an optical, capacitive or inductive manner. For this purpose, the reading unit can be used, which has already been used with conventional product ejections.

In this manner, it is in turn possible to modify conventional automatic picking machines by equipping the same with the evaluation unit of the invention implementing the method of the invention which is to be explained hereinafter. This can happen in terms of software.

Preferably, the reading unit is arranged in a vertical plane where a product stack and the dispenser are located as well.

In particular, a characteristic signal behaviour of at least one product marker is stored in the evaluation unit.

Therefore, the evaluation unit can perform a comparison of scanned signal behaviours with stored signal behaviours, which in turn allows identification of one of the product markers, and thus a change of product batches.

With another advantageous embodiment the automatic picking machine is connected to a warehouse management system indicating, on the basis of a product marker recognized in the scanned signal behaviour, how many of the products, which are dispensed during one ejection process, belong to a first product batch and/or a second product batch, wherein a change of product batches in one product stack at one chute is indicated in that the product marker is inserted preferably between a last product of the first product batch and a first product of the second product batch.

It is clear that the product marker can also be inserted between other (predetermined) products of a product batch. This depends on the previously preset definition.

In addition, the above-described problem is solved by a method for recognizing a change of product batches during an ejection of products, which are stored in chutes of an automatic picking machine, wherein the method comprises the following steps: inserting a product marker into a product stack within one of the chutes of the automatic picking machine for indicating a change of product batches, wherein the product marker is formed in accordance with the invention; scanning dispensed products and product markers by means of a reading unit, which is arranged at the dispenser immediately behind the chute, and generating a signal behaviour being characteristic for the products and/or product markers dispensed during the ejection process; evaluating the generated signal behaviour by a comparison to at least one stored characteristic signal behaviour of one product marker; and if a characteristic signal behaviour of one of the product markers is recognized, indicating that a product marker has been dispensed during the ejection process.

With a particular embodiment it is further indicated how many of the products have been dispensed during the ejection process before and/or after the product marker.

It is clear that the above-mentioned and hereinafter still to be explained features cannot only be used in the respectively given combination but also in other combinations or alone without departing from the scope of the present invention.

Embodiments of the invention are illustrated in the drawings and will be explained in further detail in the following description, wherein:

### BRIEF DESCRIPTION OF THE DRAWINGS

FIG. 1 shows a perspective view of an automatic picking machine of the invention;

FIG. 2 shows a perspective section of an automatic picking machine of the invention being provided with chutes and products;

FIG. 3 shows a schematic side view of a dispenser device of an automatic picking machine;

FIG. 4 shows a perspective view beneath a product marker of the invention;

FIG. 5 shows a perspective top view of another product marker of the present invention;

FIG. 6 shows signal behaviours in dependence on time required for dispensing one product and on the time required for dispensing one product together with a product marker; and

FIG. 7 shows a flow chart of a method of the invention.

### DESCRIPTION OF PREFERRED EMBODIMENTS

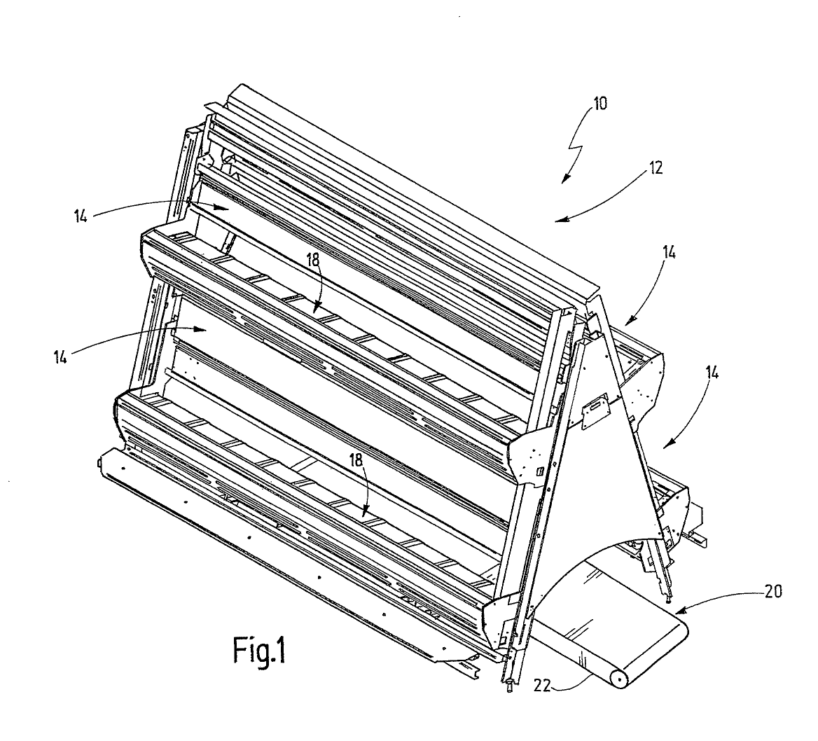

FIG. 1 shows an automatic picking machine 10 in terms of an exemplary A-shaped frame 12 as described in the document DE 20 2009 003 672 being incorporated herewith by reference.

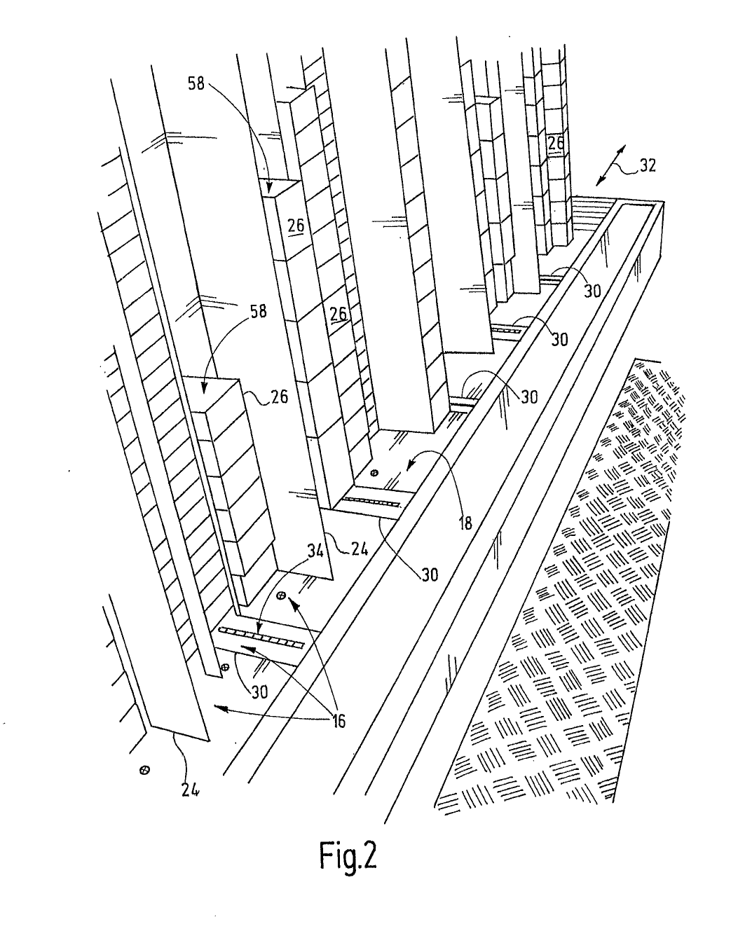

The A-shaped frame 12 comprises an A-shaped framework. Product inputs 14 are arranged at both sides of the A-shaped framework, the product inputs presently being formed at two levels respectively. The product inputs 14 are typically divided by means of chutes 16 as will be explained in more detail with reference to FIG. 2. Dispenser devices 18, which are stationary and/or supported displaceably, are arranged in a lower area of the product inputs 14. Typically, a central conveyor 20 such as a belt conveyor 22 is arranged between the legs of the A-shaped framework.

With reference to FIG. 2 a perspective view of one of the sides of the A-shaped frame 12 is depicted, wherein a lower part of one of the sides of the A-shaped frame 12 is shown. The corresponding product input 14 is divided by means of separation walls 24 being substantially arranged vertically, wherein different products 26 are stored between the separation walls 24. In the present case, the dispenser device 18 is implemented in terms of at least five dispensers 30 which here are supported in a displaceable manner, as indicated by means of a double arrow 32. The dispensers 30 are arranged at a lower end of picking chutes 58, and serve for horizontally pushing aside the lowermost articles 26. For this purpose, the dispensers 30 comprise a traction device 34 such as a toothed belt, chains, etc., which circulates endlessly in a vertical plane. A number of drivers 36, which are not depicted in FIG. 2, can be provided on the traction device 34.

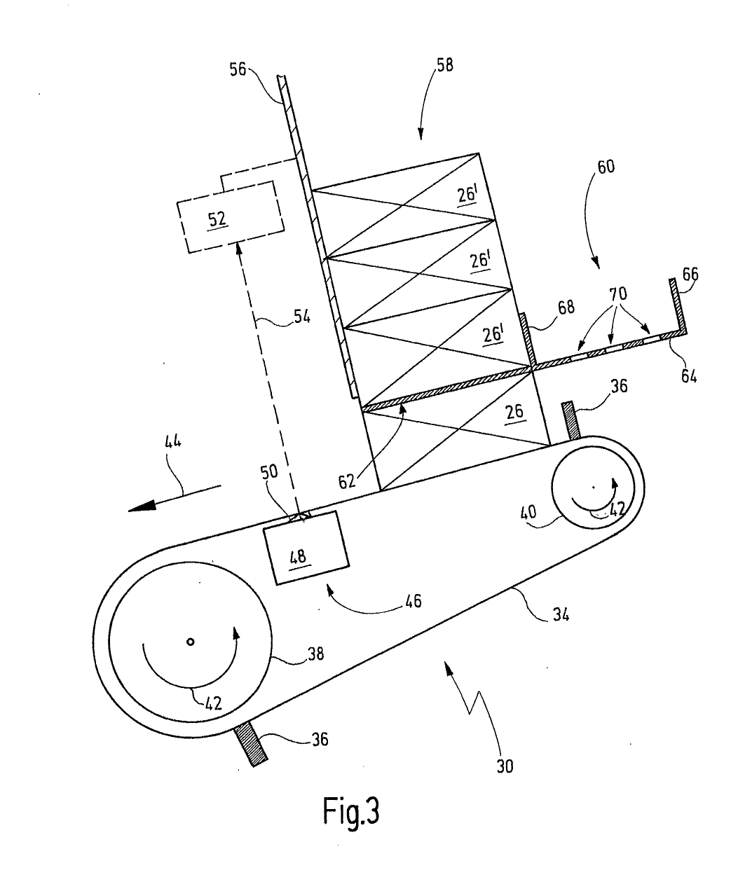

FIG. 3 shows a schematic side view of one of the dispensers 30.

The dispenser 30 comprises two idler pulleys 38 and 40 which can be driven in a counter-clockwise direction, as indicated by means of arrows 42. In this case, for example, two drivers 36 are arranged on the traction device 34, the drivers 36 pushing aside the articles 26 along a dispensing direction 44.

Further, a reading unit 46 is provided, e.g. in terms of a reflection sensor 48 operating with a reflection beam 50. Alternatively, instead of a receiver being integrated into the reflection sensor 48, a separate receiver 52 dedicated to light beams 54, which are emitted by a transmitting unit in a perpendicular manner, could be mounted to a rear wall 56 of the product input 14. The reading unit 46 is arranged in a vertical plane (e.g. perpendicular to the drawing plane), and also is operated in this vertical plane. The vertical plane of the reading unit 46 is preferably displaced relative to a plane in which the dispenser 30 is operated with its circulating traction device 34 and drivers 36, i.e. to the left in FIG. 3.

In FIG. 3, the product stack 58 consists of a last product 26 of a first product batch and three products 26′ of a second product batch, all products 26 and 26′ being of the same type. Between the last product 26 of the first product batch and the first product 26′ of the second product batch a product marker 60 according to the invention, in this case in terms of an angle 62, is inserted. The product marker 60 can also be formed without an angle, i.e. like a plate.

The angle 62 comprises a first long leg 64 (contact surface) and optionally a second, preferably shorter, leg 66 which substantially can be orientated perpendicular to each other. Further, a stop element 68 extending parallel to the second leg 66 can be connected optionally to the first leg 64. In an area between the second leg 66 and the stop element 68 a plurality of passing openings 70 can be provided in the first leg 62. These openings 70 represent a first embodiment of characteristic signal triggers. If the reflection sensor 48 is used as the reading unit 46, the holes 70 in the product marker 60 effect passage of the beam 50 through the first leg 62. Widths of the openings 70 as well as distances thereof relative to each other are characterizing the product marker 60. If the first leg 64 is sufficiently thick, the second leg 66 can be omitted. Then, the driver 36 directly abuts against the end of the first leg 64 during an ejection process.

A change of product batches will be explained hereinafter based on an embodiment shown in FIG. 3.

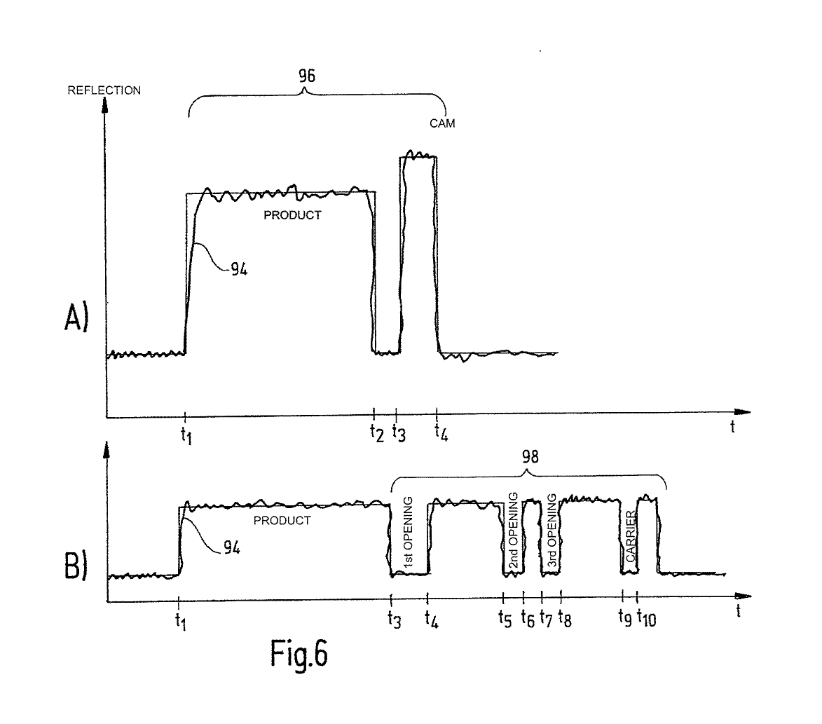

In the following, it is presumed that three products 26 (batch 1) and 26′ (batch 2) are required from the product stack 58 of FIG. 3 (consisting of one type only) for processing a picking order. For this purpose, a superordinated control such as a warehouse management computer (not shown) transmits an instruction to the dispenser 30, thereby causing the dispenser 30 to start rotating in the rotation direction 42. Then, one of the drivers 36 abuts against the last product 26 of the first product batch and pushes same along the dispensing direction 44. The objects remaining within the product stack 58 then slip vertically downwards due to gravity. The reflection sensor 48 registers the dispensed product 26, while this dispensed product 26 is passing the reflection sensor 48. The product 26 is so broad (perpendicular to the drawing plane) that the reflection sensor 48 being arranged laterally displaced can reflect the beam 50 thereof at a bottom of the dispensed product 26, and thereby can detect the same. The driver 36 also generates a reflection beam 50. The signals generated in this manner by the reflection sensor 48 will be explained below in greater detail with reference to FIG. 6.

After the last product 26 of the first product batch is dispensed, still two additional products 26′ of the product stack 58 need to be pushed aside to fulfill the order. Thus, the traction device 34 continues to rotate. The next driver 36 abuts against the (first leg 64 or an end thereof or against the) second leg 66 of the angle 62, and pushes both the first product 26′ of the second product batch and the product marker 60 along the dispensing direction 44. It is clear that the ratio in FIG. 3 is depicted overdone and is of an exemplary nature only.

The reflection sensor 48 will first detect the part of the first leg 62 on which the first product 26 is located, which is not interrupted. Subsequently, the reflection sensor 48 will detect additional reflections and interruptions, wherein the interruptions are caused by the holes 70. Finally, the reflection sensor 48 will detect the second driver 36 during the ejection process.

Subsequently, still another product 26—presently the second product 26′—will be dispensed. In this case, the ejection process described in the context of the last product 26 of the first product batch is repeated because no additional product marker 60 is in contact with the second product 26′ of the second batch.

It is clear that the presently described optical embodiment of the measurement could also be realized in a capacitive or inductive manner. As an alternative to the reflection beam 50, a light barrier having a light beam 54 emitted perpendicular upwards could be implemented by means of a receiver 52.

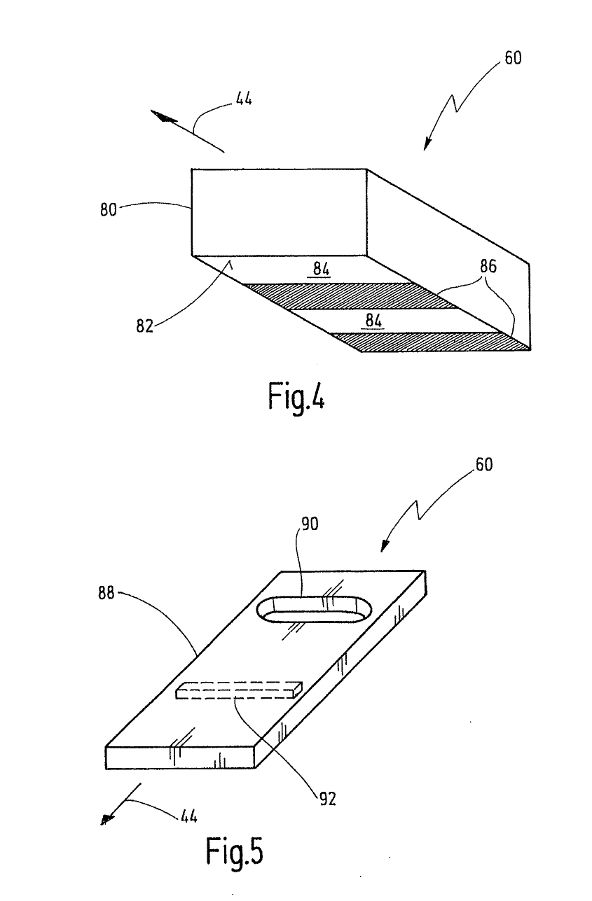

Another product marker 60 is shown in FIG. 4 in terms of a dummy 80. The dummy 80 can comprise different color stripes 84 and 86 at a bottom 82 thereof. The stripes 84 can be bright. The stripes 86 can be dark. Both types of stripes 84 and 86 reflect the reflection beam 50 at different intensities, and thus can also be recognized unambiguously.

The stripes 84 and 86 shown in FIG. 4 can also be printed on a separate foil, which in this case is attached to the product at a suitable position like a sticker which can be removed again, if necessary. The sticker solution allows usage of real products. In this case, the product 80 of FIG. 4 would be no dummy. Product markers in terms of stickers are particularly suitable for usage with round products where markers, for example, having an angled shape, can only be used insufficiently. The stickers can be removed again later, if desired, or remain on the product if possible.

Another alternative of a product marker 60 is shown in FIG. 5. In this case, the product marker 60 is implemented in terms of a plate 88. The plate 88 can either comprise openings 90 extending substantially transversal relative to the dispensing direction 44. However, the plate 88 can also have regions 92 in the body thereof reacting magnetically in particular, thereby allowing, for example, inductive measurements.

With reference to FIG. 6 two signal behaviours 94 of a “normal ejection” of an isolated product 26 (cf. FIG. 6A) as well as of a common ejection of one product 26 together with a product marker 60 (cf. FIG. 6B) are depicted.

With the arrangement of FIG. 3 the reflection sensor 48 “sees” the product 26 first and subsequently the driver 36 or a cam. The signal behaviour 94 illustrated in FIG. 6A represents a normal signal behaviour 96 without any product marker 60. The product begins to reflect the beam 50 at a time t1. The product has passed the sensor 48 at the time t2. A short-time drop of the reflection signal occurs at the time t3, if the driver 36 reflects the beam 50 once again until the time t4.

Similar is true with regard to the signal behaviour 94 of FIG. 6B, whereas the reflection signal of the product only drops a short time later, namely if the sensor 48 is passed by a first opening of the openings 70. Subsequently, the reflection signal increases again for being interrupted once again at the time t5 due to a second opening in the first leg 64 of the product marker 62 (cf. FIG. 3). At the time t6 the signal increases again, because the product marker 62 comprises material adapted to reflect, until the signal decreases again at the time t7 due to a third opening. At the time t8 it increases again for subsequently decreasing again at the time t9 when the product marker 62 has completely passed the sensor 48. Subsequently, the driver 36 can still be recognized in the reflection signal.

The measured signal behaviour 94 can be examined by means of recognition algorithms, which are nowadays available, wherein the examination focuses on the normal signal behaviour 96 as well as on a characteristic signal behaviour 98 (cf. FIG. 6B) such as the one being caused by the product marker 62 of FIG. 3.

It is clear that a plurality of different characteristic signal behaviours 98 can be stored in an evaluation unit either arranged directly in the automatic picking machine 10 or at the warehouse management computer. In this manner it is possible to allow safe registration of ejections processes of product markers 60 at any time.

The signal triggers (e.g. the holes 70) can vary arbitrarily with regard to their extension parallel to the dispensing direction 44 as well as with regard to their distances relative to each other. In this manner, unambiguous labels (“melodies”) can be generated so that in general not only the ejection process of one of the product marker 60 can be registered, but it can also be registered which specific one of the product markers 60 was just dispensed.

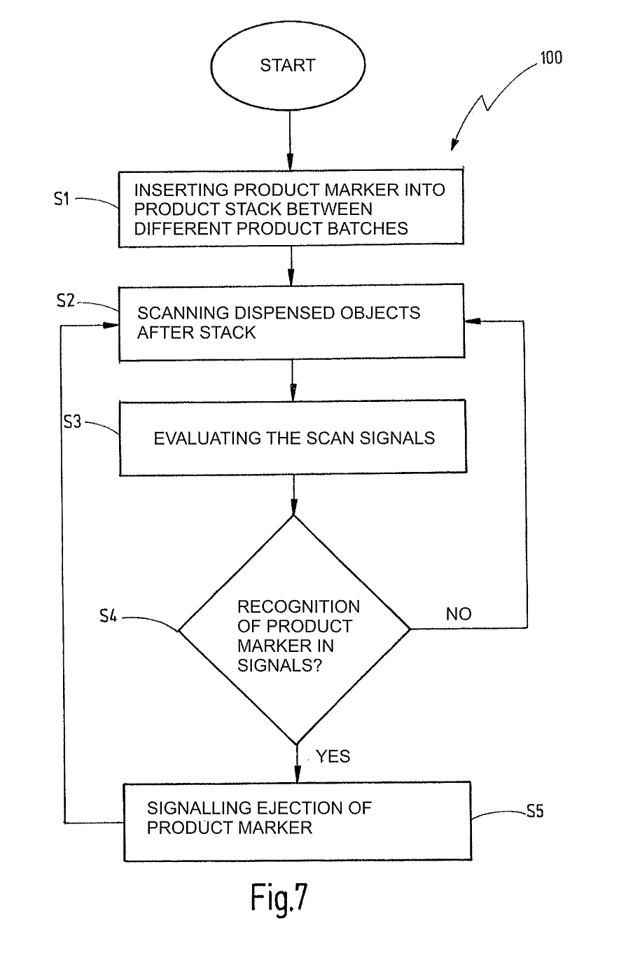

The method of the invention is once again shown in an abstract manner in terms of a flow chart 100 in FIG. 7.

In a first step S1 product markers 60 are inserted into the product stack 58 between different product batches. In a step S2 objects, which are dispensed, are scanned behind the product stack 58, for example, by means of the reflection sensor 48. In a step S3 the signals 94 are evaluated, which are generated by the scan. In an inquiry S4 it is queried whether one of the product markers 60 was recognized in the signal 94. If no product marker 60 was recognized, one can return to the step S2. If a product marker 60 was recognized, the ejection process of one of the product markers 60 can be indicated, thereby also resulting immediately in a change of product batches.

The above-described product markers in accordance with the present invention can also be used certainly outside an A-shaped frame. The usage can also occur freely of an automatic picking machine, which is advantageous in connection with a bar code on the marker for the purpose of an unambiguous identification.

Further, it is clear that the ejection instruction must not necessarily come from the warehouse management computer. An ejection process can also be initiated, for example, by an SPC (stored-program controller) being assigned to the automatic picking machine for controlling directly the function thereof. For this purpose, the SPC can receive the instruction from a superordinated information level to throw chutes i-j in a window on the central belt, which is assigned to the picking order which is just processed. In this case, the SPC does not know which of the products (in terms of product types) is stored in which one of the chutes. The assignment (by one type only) of a product type (e.g. Aspirin) to one of the chutes is stored at a higher information level but not in the control of the automatic picking machine. The same can apply to the number of a quantity of products of the same type (e.g. Aspirin) being stored in one of the chutes. In this case, the recognition of one of the markers merely leads to recordation of information at a next higher information level (information: “All of the ejections processes of chute X, from now on, are of the product type Y”). Additionally, also information can be derived that the marker was recognized during the n^{th} ejection process and the picking order A contains n−1 products of the type Y (e.g. batch 1) and m products of the type Z (e.g. batch 2).

The terms “dispense” and “eject” have been used in an equivalent manner, and therefore have an equal meaning. Terms like “vertical”, “horizontal”, “above”, “beneath”, “behind” and the like refer to the respectively described drawing, and are not to be understood as restricting the invention to a specific orientation. If position and orientation of the object are changed, the respective terms need to be adapted correspondingly.

What is claimed is:

1. An automatic picking machine comprising:
a chute for storing products of different product batches in a stack and by one type only;
a dispenser having a circulating driver for automatically separating the products and being arranged at an end of the chute, wherein the dispenser is assigned to the reading unit scanning a product marker;
a reading unit being arranged in an area of the dispenser and adapted to scan an object and transmit a signal; and
the product marker for usage with the automatic picking machine, wherein the product marker is formed such that the product marker is insertable between such products in the chute, which are belonging to the different product batches, and is dispensable together with a first product or a last product of one of the product batches by means of the dispenser, wherein the product marker comprises a sequence of characteristic signal triggers which can be scanned and transmitted as a signal by the reading unit if the product marker passes the reading unit during an ejection process, wherein the product marker has a first leg extending in a plane in which the products within the stack lie on top of each other, and wherein the signal triggers have preset widths and are arranged one after the other at pre-set distances relative to each other along a dispensing direction; and
an evaluation unit being adapted to examine a signal, generated from a scanned sequence of characteristic signal triggers when the product marker passes the reading unit during the ejection process, for a signal behaviour being characteristic for the dispensed product marker and differing from a typical signal behaviour caused by a combination of one of the products and the driver, if they are passing the reading unit.

2. The automatic picking machine of claim 1, wherein the reading unit is substantially arranged in a vertical plane in which the product stack and the dispenser are located.

3. The automatic picking machine of claim 1, wherein characteristic signal behaviour of at least one product marker is stored in the evaluation unit, thereby allowing the evaluation unit to compare scanned signal behaviours with stored signal behaviours.

4. The automatic picking machine of claim 1, further comprising a warehouse management system indicating, on the basis of a product marker recognized in a scanned signal behaviour, how many products, which have been dispensed during the ejection process, belong to a first or second product batch of the different product batches, wherein change of product batches in the product stack at the chute is indicated in that the product marker is inserted between a last product of the first product batch and a first product of the second product batch.

5. A product marker for usage in an automatic picking machine, the automatic picking machine comprising: a chute; a dispenser having a circulating driver for automatically separating products, which are stored in a stack and by one type only within the chute; wherein the dispenser is arranged at an end of the chute; and a reading unit, which is arranged near the dispenser;
the product marker being formed such that the product marker is insertable between such products in the chute, which are belonging to different product batches, and dispensable together with a first product or a last product of one of the product batches by means of the dispenser;
wherein the product marker comprises a sequence of characteristic signal triggers, which can be scanned and transmitted as a signal by the reading unit if the product marker passes the reading unit during an ejection process, the reading unit being arranged in an area of the dispenser;
wherein the product marker has a first leg extending in a horizontal plane in which the products within the stack lie on top of each other; and
wherein the signal triggers have preset widths and are arranged one after the other at preset distances relative to each other along a dispensing direction.

6. The product marker of claim 5, further comprising a second leg extending in a vertical plane in which the driver of the dispenser contacts the products during the ejection process.

7. The product marker of claim 6, further comprising a stop element provided in a plane parallel to the second leg, the stop element being connected to the first leg and preventing, at the time of the ejection process, displacement of the product marker relative to the to-be-dispensed product, which is in contact with the product marker.

8. The product marker of claim 5, further comprising a body, wherein the characteristic signal triggers are through openings in the body of the product marker.

9. The product marker of claim 5, further comprising a diamagnetic body, wherein the characteristic signal triggers are metal stripes integrated in the diamagnetic body of the product marker.

10. The product marker of claim 5, wherein the characteristic signal triggers are color stripes reflecting at different intensities.

11. The product marker of claim 5, wherein the widths and distances represent a characteristic label of the product marker which can be identified unambiguously in the signal of the reading unit scanning the product marker during passage thereof.

12. The product marker of claim 5, wherein the signal triggers substantially extend transversally to the dispensing direction.

13. The product marker of claim 5, which is substantially plate-like.

14. A method for recognizing a change of product batches during ejection of products being stored in a chute of an automatic picking machine, the automatic picking machine comprising: a chute for storing products of different product batches in a stack and by one type only; a reading unit; a dispenser having a circulating driver for automatically separating the products and being arranged at an end of the chute, wherein the dispenser is assigned to the reading unit scanning a product marker; and the product marker for usage with the automatic picking machine, wherein the product marker is formed such that the product marker is insertable between such products in the chute, which are belonging to the different product batches, and is dispensable together with a first product or a last product of one of the product batches by means of the dispenser, wherein the product marker comprises a sequence of characteristic signal triggers which can be scanned and transmitted as a signal by the reading unit if the product marker passes the reading unit during an ejection process, the reading unit being arranged in an area of the dispenser, wherein the product marker has a first leg extending in a horizontal plane in which the products within the stack lie on top of each other, and wherein the signal triggers have preset widths and are arranged one after the other at pre-set distances relative to each other along a dispensing direction; and an evaluation unit being adapted to examine a signal, generated by the scanning of the sequence of characteristic signal triggers of the product marker when the product marker passes the reading unit during the ejection process, on a signal behaviour being characteristic for the dispensed product marker and distinguishing from a typical signal behaviour caused by a combination of one of the products and the driver, if they are passing the reading unit; the method comprising the following steps:
inserting the product marker into the product stack in the chute of the automatic picking machine for indicating a change of product batches;
scanning dispensed products and product markers by means of the reading unit which is arranged immediately behind the chute at the dispenser;
generating a signal behaviour being characteristic for the dispended product and the product marker dispensed during the ejection process;
evaluating the generated signal behaviour by a comparison with at least one stored characteristic signal behaviour of the product marker; and
if a characteristic signal behaviour of the dispensed product marker is recognized, identifying the product marker which was dispensed during the ejection process.

15. A method of claim 14, further comprising the step of:
counting and indicated how many products have been dispensed during the ejection process before and/or after the identified product marker.

16. The automatic picking machine of claim 1, wherein the chute is orientated substantially vertical.
